(19) United States
(12) Patent Application Publication
(10) Pub. No.: US 2026/0011802 A1
(43) Pub. Date: Jan. 8, 2026

(54) BIPOLAR ELECTRODE, BIPOLAR BATTERY, AND METHOD OF PRODUCING RECYCLED MATERIAL

(71) Applicant: TOYOTA JIDOSHA KABUSHIKI KAISHA, Aichi-ken (JP)

(72) Inventors: Kazuhito KATO, Toyota-shi (JP); Takeshi ABE, Toyota-shi (JP); Nariaki MIKI, Okazaki-shi (JP); Satoshi MORIOKA, Okazaki-shi (JP); Seigo FUJISHIMA, Miyoshi-shi (JP); Tomohiro YOKOYAMA, Toyota-shi (JP); Masashi KATO, Konan-shi (JP)

(21) Appl. No.: 19/250,065

(22) Filed: Jun. 26, 2025

(30) Foreign Application Priority Data
Jul. 2, 2024 (JP) 2024-106799

(51) Int. Cl. H01M 10/54; H01M 4/02; H01M 4/36

(52) U.S. Cl. CPC H01M 10/54; H01M 4/362; H01M 2004/029

(57) ABSTRACT

A bipolar electrode includes, in sequence in a plane-perpendicular direction: a positive electrode composite material layer; a positive electrode current collector foil; an interposition film; a negative electrode current collector foil; and a negative electrode composite material layer. Each of the positive electrode current collector foil and the negative electrode current collector foil is attached to the interposition film. The positive electrode composite material layer is attached to the positive electrode current collector foil. The negative electrode composite material layer is attached to the negative electrode current collector foil. The interposition film has conductivity. The bipolar electrode is configured such that at least one of the positive electrode current collector foil and the negative electrode current collector foil is separated from the interposition film before the interposition film is broken when the interposition film is stretched in an in-plane direction.

### CROSS REFERENCE TO RELATED APPLICATIONS

This nonprovisional application is based on Japanese Patent Application No. 2024-106799 filed on Jul. 2, 2024 with the Japan Patent Office, the entire contents of which are hereby incorporated by reference.

### BACKGROUND

### Field

The present disclosure relates to a bipolar electrode, a bipolar battery, and a method of producing a recycled material.

### Description of the Background Art JP-A-2022-114963 discloses a method of recovering a metal material from a bipolar electrode.

### SUMMARY

Recycling by recovering a material from a battery that has become unnecessary has been required. A positive electrode and a negative electrode can be individually recovered from a monopolar battery. The positive electrode and the negative electrode include different groups of materials. In general, a process of obtaining a recycled material from the positive electrode is different from a process of obtaining a recycled material from the negative electrode.

A bipolar battery includes a bipolar electrode. In the bipolar electrode, a positive electrode and a negative electrode are integrated. In order to obtain a recycled material from the bipolar electrode, it is first required to separate the bipolar electrode into a positive electrode and a negative electrode.

It is an object of the present disclosure to provide a bipolar electrode that can be readily separated into a positive electrode and a negative electrode.

1. One aspect of the present disclosure is a bipolar electrode. The bipolar electrode includes, in sequence in a plane-perpendicular direction: a positive electrode composite material layer; a positive electrode current collector foil; an interposition film; a negative electrode current collector foil; and a negative electrode composite material layer. Each of the positive electrode current collector foil and the negative electrode current collector foil is attached to the interposition film. The positive electrode composite material layer is attached to the positive electrode current collector foil. The negative electrode composite material layer is attached to the negative electrode current collector foil. The interposition film has conductivity. The bipolar electrode is configured such that at least one of the positive electrode current collector foil and the negative electrode current collector foil is separated from the interposition film before the interposition film is broken when the interposition film is stretched in an in-plane direction.

The positive electrode composite material layer and the positive electrode current collector foil constitute a positive electrode. The negative electrode composite material layer and the negative electrode current collector foil constitute a negative electrode. Conventionally, a positive electrode current collector foil is adhered to a negative electrode current collector foil by, for example, an adhesive or the like. For example, when the positive electrode current collector foil is detached from the negative electrode current collector foil by applying a strong external force in the plane-perpendicular direction, contamination may occur between the positive electrode and the negative electrode due to breakage of each member or the like. With the contamination, a yield of a recycled material may be reduced.

In the present disclosure, the interposition film couples the positive electrode current collector foil and the negative electrode current collector foil. In the bipolar electrode according to the present disclosure, at least one of the positive electrode current collector foil and the negative electrode current collector foil is configured to be separated from the interposition film by stretching the interposition film in the in-plane direction. That is, the bipolar electrode can be readily separated into the positive electrode and the negative electrode by stretching the interposition film in the in-plane direction.

2. The bipolar electrode according to “1” may include, for example, the following configuration. The interposition film has a total elongation at break larger than a total elongation at break of each of the positive electrode current collector foil and the negative electrode current collector foil.

Since the total elongation at break of the interposition film is larger than the total elongation at break of each of the positive electrode current collector foil and the negative electrode current collector foil, when the interposition film is stretched in the in-plane direction, the positive electrode current collector foil and the negative electrode current collector foil cannot follow the elongation (deformation) of the interposition film, with the result that the positive electrode current collector foil and the negative electrode current collector foil can be detached from the interposition film.

3. The bipolar electrode according to “1” or “2” may include, for example, the following configuration. In the in-plane direction, the interposition film protrudes outward with respect to each of the positive electrode current collector foil and the negative electrode current collector foil.

The protrusion of the interposition film can serve as a gripping margin (grip) when stretching the interposition film.

4. One aspect of the present disclosure is a bipolar battery. The bipolar battery includes the bipolar electrode according to any one of “1” to “3”.

5. One aspect of the present disclosure is a method of producing a recycled material. The method of producing a recycled material includes the following (a) and (b).

(a) The bipolar electrode according to any one of “1” to “3” is prepared.

(b) At least one of the positive electrode current collector foil and the negative electrode current collector foil is separated from the interposition film by stretching the interposition film in the in-plane direction.

Hereinafter, one embodiment (hereinafter, also simply referred to as “the present embodiment”) of the present disclosure will be described. It should be noted that the present embodiment does not limit the technical scope of the present disclosure. The present embodiment is illustrative in all respects. The present embodiments are non-limiting. The technical scope of the present disclosure includes all the modifications within the meaning and scope equivalent to the description of the claims. For example, it is also initially expected that any configurations are extracted from the present embodiment and are freely combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic cross-sectional view showing an example of a bipolar electrode according to the present embodiment.

FIG. 2 is a schematic cross-sectional view showing a first separation mode.

FIG. 3 is a schematic cross-sectional view showing a second separation mode.

FIG. 4 is an example of a stress strain diagram.

FIG. 5 is a schematic cross-sectional view illustrating an example of a bipolar battery according to the present embodiment.

FIG. 6 is a schematic flowchart showing a method of producing a recycled material in the present embodiment.

### DESCRIPTION OF THE PREFERRED EMBODIMENTS

### Terms and Phrases

Geometric terms are not to be construed in a strict sense. Examples of geometric terms include “parallel”, “perpendicular”, and “orthogonal”. For example, directions, angles, distances, and the like may be relatively displaced within a range in which substantially the same or similar functions are obtained. Geometric terms may include, for example, tolerances such as design tolerance, work tolerance, production tolerance, errors, and the like. The dimensional relationship in each drawing may not coincide with the actual dimensional relationship. To aid the reader's understanding, the dimensional relationships in the figures may be varied. For example, the length, width, thickness, and the like may be changed. Some components may be omitted.

The “plane-perpendicular direction” indicates a normal direction to the surface of the electrode. The plane-perpendicular direction can be referred to as, for example, a thickness direction. The “in-plane direction” indicates any direction perpendicular to the plane-perpendicular direction.

### Bipolar Electrode

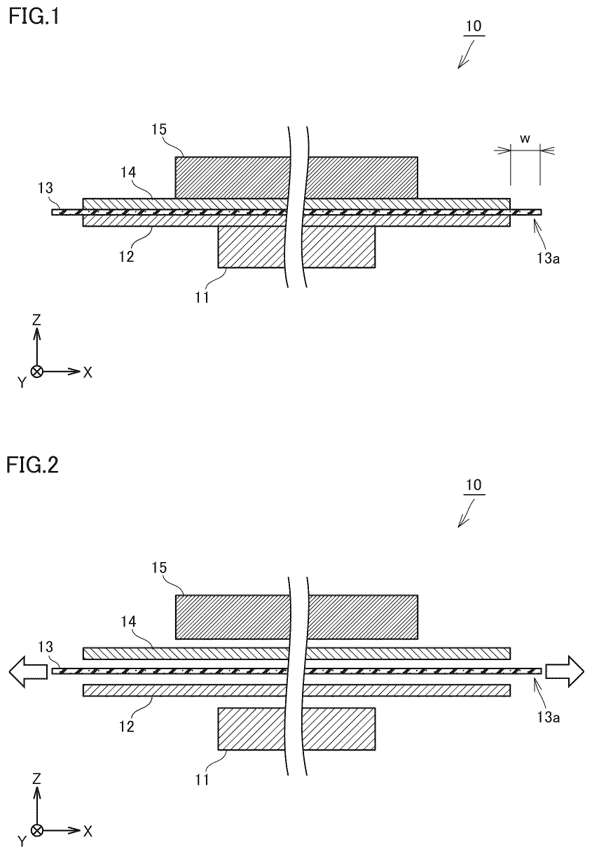

FIG. 1 is a schematic cross-sectional view showing an example of a bipolar electrode according to the present embodiment. The bipolar electrode 10 includes a positive electrode composite material layer 11, a positive electrode current collector foil 12, an interposition film 13, a negative electrode current collector foil 14, and a negative electrode composite material layer 15 in this order in a plane-perpendicular direction (Z-axis direction). The bipolar electrode 10 can have any planar shape. The bipolar electrode 10 may have, for example, a rectangular planar shape. In the bipolar electrode 10, at least one of the positive electrode current collector foil 12 and the negative electrode current collector foil 14 is configured to be separated from the interposition film 13 before the interposition film 13 is broken when the interposition film 13 is stretched in the in-plane direction. The X-axis direction and the Y-axis direction in FIG. 1 are examples of in-plane directions.

Positive electrode composite material layer 11 is attached to positive electrode current collector foil 12. The thickness of the positive electrode composite material layer 11 may be, for example, 10 to 1000 μm. For example, grooves (not shown) may be formed in the positive electrode composite material layer 11. The positive electrode composite material layer 11 contains a positive electrode active material. The positive electrode active material may contain an optional component. The positive electrode active material may include, for example, a lamellar-type lithium metal composite oxide, an olivine-type phosphate compound, or the like. The positive electrode active material may contain various valuable metals. The positive electrode composite material layer 11 may further include, for example, a conductive material, a binder, and the like in addition to the positive electrode active material.

The positive electrode current collector foil 12 adheres to the interposition film 13. The positive electrode current collector foil 12 may have a thickness of, for example, 5 to 100 μm. The positive electrode current collector foil 12 may include, for example, an aluminum foil, an aluminum alloy foil, a titanium foil, or a stainless steel foil.

The negative electrode current collector foil 14 adheres to the interposition film 13. The negative electrode current collector foil 14 may have a thickness of, for example, 5 to 100 μm. The negative electrode current collector foil 14 may include, for example, a copper foil, a copper alloy foil, a nickel foil, a nickel alloy foil, or the like.

The negative electrode composite material layer 15 adheres to the negative electrode current collector foil 14. The thickness of the negative electrode composite material layer 15 may be, for example, 10 to 1000 μm. The negative electrode composite material layer 15 contains a negative electrode active material. The negative electrode active material may contain an optional component. The negative electrode active material may include, for example, silicon, silicon oxide, graphite, spinel-type titanium oxide, or the like. Negative electrode composite material layer 15 may further contain, for example, a conductive material, a binder, and the like in addition to the negative electrode active material.

The interposition film 13 is interposed between the positive electrode current collector foil 12 and the negative electrode current collector foil 14. The interposition film 13 couples the positive electrode current collector foil 12 and the negative electrode current collector foil 14. The interposition film 13 has a first main surface and a second main surface. The second main surface is opposite to the first main surface. The positive electrode current collector foil 12 may be attached to the first main surface. The negative electrode current collector foil 14 may be attached to the second main surface.

The thickness of the interposition film 13 may be, for example, 3 μm or more, 5 μm or more, or 10 μm or more. The thickness of the interposition film 13 may be, for example, 30 μm or less, 20 μm or less, or 15 μm or less.

The interposition film 13 may have a protrusion 13a. In the in-plane direction (for example, the X-axis direction), the protrusion 13a protrudes outward with respect to the positive electrode current collector foil 12 and the negative electrode current collector foil 14. The protruding amount (w) of the protrusion 13a may be, for example, 1 mm or more, 5 mm or more, or 10 mm or more. The protruding amount (w) of the protrusion 13a may be, for example, 20 mm or less, 15 mm or less, or 10 mm or less.

The interposition film 13 may be, for example, a free-standing film. The interposition film 13 may include, for example, a resin film. The resin film may include, for example, a resin material, a rubber material, an elastomer material, or the like. The resin film may contain, for example, fluoro-resin, acrylic resin, polyimide resin, polyester resin, fluoro-rubber, urethane rubber, silicone rubber, fluoro-elastomer, urethane elastomer, or the like.

The interposition film 13 has conductivity (electron conductivity). The positive electrode current collector foil 12 and the negative electrode current collector foil 14 are electrically connected to each other through the interposition film 13. The interposition film 13 may include, for example, a conductive filler or the like. For example, the resin film may be a continuous phase (matrix material), and the conductive filler may be a dispersed phase. The interposition film 13 may include, for example, 1 to 50% of the conductive filler in mass fraction and the remaining resin film. The conductive filler may include, for example, metal particles, carbon black, carbon fibers, carbon nanotubes, and the like.

The interposition film 13 has a bonding force. The interposition film 13 may include, for example, an adhesive or the like. For example, a conductive adhesive may be applied to both surfaces of the resin film. The conductive adhesive may contain, for example, a base material, a curing agent, and a conductive filler. The base material may contain, for example, an olefin-based resin or the like. The curing agent may contain, for example, a compound having an isocyanate group. The conductive filler is as described above.

### Tensile Properties

The interposition film 13 may have certain tensile properties. For example, the interposition film 13 may have a larger total elongation at break than the positive electrode current collector foil 12 and the negative electrode current collector foil 14. Since the total elongation at break of the interposition film 13 is large, when the interposition film 13 is stretched in the in-plane direction, the positive electrode current collector foil 12 and the negative electrode current collector foil 14 cannot follow the elongation (deformation) of the interposition film 13, and can be detached.

Therefore, for example, when the interposition film 13 is stretched in the in-plane direction and the positive electrode current collector foil 12 peels off before the interposition film 13 breaks, it can be determined that the total elongation at break of the interposition film 13 is larger than the total elongation at break of the positive electrode current collector foil 12. For example, when the interposition film 13 is stretched in the in-plane direction and the negative electrode current collector foil 14 peels off before the interposition film 13 breaks, it can be determined that the total elongation at break of the interposition film 13 is larger than the total elongation at break of the negative electrode current collector foil 14.

FIG. 2 is a schematic cross-sectional view showing a first separation mode. In the first separation mode, for example, the following relationship may be satisfied.

ε₁₁<ε₁₂<ε₁₃
ε₁₃: total elongation at break of interposition film 13
ε₁₁: total elongation at break of positive electrode composite material layer 11
ε₁₂: total elongation at break of positive electrode current collector foil 12

When the relationship of “ε₁₁<ε₁₂<ε₁₃” is satisfied, peeling of the positive electrode composite material layer 11 from the positive electrode current collector foil 12 and peeling of the positive electrode current collector foil 12 from the interposition film 13 may occur in this order. That is, the positive electrode current collector foil 12 and the positive electrode composite material layer 11 can be collected individually. The first separation mode is suitable for a recycling process in which the positive electrode current collector foil 12 and the positive electrode composite material layer 11 are treated individually. Further, for example, a reduction in contamination from the positive electrode current collector foil 12 to the positive electrode composite material, an improvement in recovery efficiency, and the like are also expected.

For example, the following relationship may be satisfied on the negative electrode side as well as on the positive electrode side.

ε₁₅<ε₁₄<ε₁₃
ε₁₃: total elongation at break of interposition film 13
ε₁₄: total elongation at break of negative electrode current collector foil 14
ε₁₅: total elongation at break of negative electrode composite material layer 15

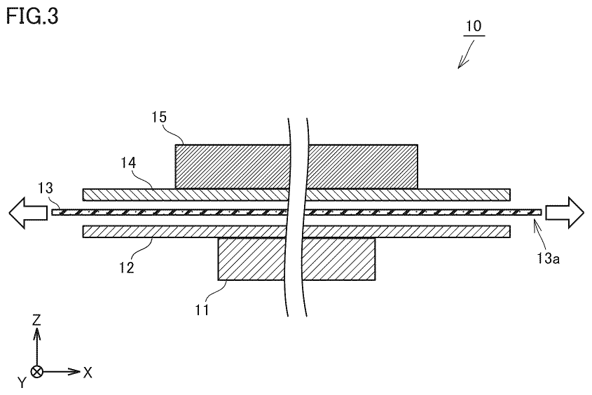

FIG. 3 is a schematic cross-sectional view showing a second separation mode. In the second separation mode, for example, the following relationship may be satisfied.

ε₁₂<ε₁₁<ε₁₃
ε₁₃: total elongation at break of interposition film 13
ε₁₁: total elongation at break of positive electrode composite material layer 11
ε₁₂: total elongation at break of positive electrode current collector foil 12

When the relationship of “ε₁₂, ε₁₁, ε₁₃” is satisfied, the positive electrode composite material layer 11 and the positive electrode current collector foil 12 can be detached from the interposition film 13 together. The second separation mode is suitable for a recycling process in which the positive electrode composite material layer 11 and the positive electrode current collector foil 12 are collectively treated. For example, a process of collectively dissolving the positive electrode composite material layer 11 and the positive electrode current collector foil 12 may be considered. When the positive electrode composite material layer 11 and the positive electrode current collector foil 12 are processed together, for example, a decrease in recovery efficiency due to adhesion of the positive electrode composite material to the positive electrode current collector foil 12 may not be considered.

For example, the following relationship may be satisfied on the negative electrode side as well as on the positive electrode side.

ε₁₄<ε₁₅<ε₁₃
ε₁₃: total elongation at break of interposition film 13
ε₁₄: total elongation at break of negative electrode current collector foil 14
ε₁₅: total elongation at break of negative electrode composite material layer 15

The ratio “ε₁₃/ε₁₂” of the total elongation at break “ε₁₃” of the interposition film 13 to the total elongation at break “ε₁₂” of the positive electrode current collector foil 12 may be, for example, 1.001 or more, 1.01 or more, 1.03 or more, 1.05 or more, 1.1 or more, 1.2 or more, 1.5 or more, or 2 or more. The ratio “ε₁₃/ε₁₂” of the total elongation at break may be, for example, 10 or less, 5 or less, 3 or less, or 2 or less.

The ratio “ε₁₁/ε₁₂” of the total elongation at break “ε₁₁” of the positive electrode composite material layer 11 to the total elongation at break “ε₁₂” of the positive electrode current collector foil 12 may be, for example, 0.1 or more, 0.3 or more, 0.5 or more, 0.7 or more, 1 or more, 2 or more, 3 or more, or 5 or more. The ratio of the total elongation at break “ε₁₁/ε₁₂” may be, for example, 10 or less, 5 or less, 3 or less, 2 or less, 1 or less, 0.7 or less, 0.5 or less, or 0.3 or less.

The ratio “ε₁₃/ε₁₄” of the total elongation at break “ε₁₃” of the interposition film 13 to the total elongation at break “ε₁₄” of the negative electrode current collector foil 14 may be, for example, 1.001 or more, 1.01 or more, 1.03 or more, 1.05 or more, 1.1 or more, 1.2 or more, 1.5 or more, or 2 or more. The ratio “ε₁₃/ε₁₄” of the total elongation at break may be, for example, 10 or less, 5 or less, 3 or less, or 2 or less.

The ratio “ε₁₅/ε₁₄” of the total elongation at break “ε₁₅” of the negative electrode composite material layer 15 to the total elongation at break “ε₁₄” of the negative electrode current collector foil 14 may be, for example, 0.1 or more, 0.3 or more, 0.5 or more, 0.7 or more, 1 or more, 2 or more, 3 or more, or 5 or more. The ratio of the total elongation at break “ε₁₅/ε₁₄” may be, for example, 10 or less, 5 or less, 3 or less, 2 or less, 1 or less, 0.7 or less, 0.5 or less, or 0.3 or less.

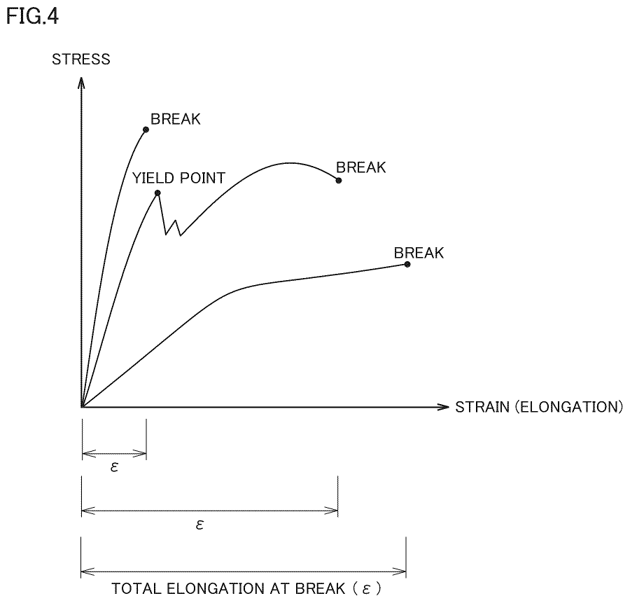

FIG. 4 is an example of a stress strain diagram. The stress-strain diagram may be obtained by tensile testing of each member. For example, a tensile tester of grade 1 or higher according to “JIS B 7721” may be used. A test piece of the same size is produced from each member. The test force may be adjusted, for example, in the range of 100 to 300 MPa. The strain rate may be adjusted, for example, in the range of 0.01 to 1%/s. In the stress-strain diagram, the vertical axis represents stress and the horizontal axis represents strain. Three measurement examples are shown in FIG. 4. The stress-strain curve may or may not have a yield point. In any case, the total elongation at break (ε) is the sum of the elastic elongation of the elongation meter at break and the plastic elongation. The total elongation at break is expressed in percentage with respect to the elongation meter target distance.

The total elongation at break of the interposition film 13 can be adjusted by, for example, the type of resin material or the like and the type of conductive filler (fibrous conductive filler or the like). The total elongation at break of the positive electrode current collector foil 12 and the negative electrode current collector foil 14 can be adjusted by, for example, the type of metal foil (alloy material) or the like. The total elongation at break of the positive electrode composite material layer 11 and the negative electrode composite material layer 15 can be adjusted by, for example, the type of binder, the mass fraction (compounding amount) of the binder, and the like. For example, when a fibrous binder (e.g., polytetrafluoroethylene or the like) or a binder having high elongation (e.g., polyvinylidene difluoride or the like) is selected, the total elongation at break of the composite material layer is expected to increase.

### Bipolar Battery

FIG. 5 is a schematic cross-sectional view illustrating an example of a bipolar battery according to the present embodiment. The bipolar battery 100 may include an exterior package 90, a power generating element 50, and an electrolyte solution (not shown). The exterior package 90 may include, for example, a first current collector plate 91, a first laminate film 92, a second laminate film 93, and a second current collector plate 94. The exterior package 90 houses the power generating element 50.

The power generating element 50 includes a bipolar electrode 10, a separator 20, an electrolyte solution (not shown), and a sealing material 30. That is, the bipolar battery 100 includes the bipolar electrode 10. The plurality of bipolar electrodes 10 are stacked in a plane-perpendicular direction (Z-axis direction). That is, the plane-perpendicular direction of the bipolar electrode 10 corresponds to the stacking direction of the power generating elements 50.

The power generating element 50 may further include a termination unit in addition to the bipolar electrode 10. The termination unit is disposed at an end portion in the stacking direction. The termination unit may have, for example, a monopolar structure. The termination unit may consist of, for example, the positive electrode composite material layer 11 and the positive electrode current collector foil 12. The termination unit may consist of, for example, the negative electrode composite material layer 15 and the negative electrode current collector foil 14.

The separator 20 is disposed between the bipolar electrodes 10. Separator 20 separates adjacent positive electrode composite material layer 11 and negative electrode composite material layer 15. The separator 20 may include, for example, a porous film or the like. A portion surrounded by the positive electrode current collector foil 12 and the negative electrode current collector foil 14 with the separator 20 interposed therebetween constitutes a unit battery (cell). Since the bipolar battery 100 includes a plurality of cells, it may be referred to as, for example, a “bipolar module”. Each cell is filled with the electrolyte solution.

At the periphery in the in-plane direction, the sealing material 30 fills the gap between the bipolar electrodes 10. The sealing material 30 may include, for example, an epoxy resin or the like. The sealing material 30 may have, for example, a lower melting point than the interposition film 13. For example, when the power generating element 50 is disassembled, the interposition film 13 may be separated from the sealing material 30 by selectively melting the sealing material 30. The difference in melting point between the sealing material 30 and the interposition film 13 may be, for example, 10° C. or more, 30° C. or more, 50° C. or more, or 100° C. or more. The difference in melting point between the sealing material 30 and the interposition film 13 may be, for example, 200° C. or less, 150° C. or less, or 100° C. or less.

The sealing material 30 may have, for example, a thermal decomposition temperature lower than the melting point of the interposition film 13. For example, when the power generating element 50 is disassembled, the sealing material 30 may be thermally decomposed to separate the interposition film 13 from the sealing material 30. The difference between the thermal decomposition temperature of the sealing material 30 and the melting point of the interposition film 13 may be, for example, 10° C. or more, 30° C. or more, 50° C. or more, or 100° C. or more. The difference between the thermal decomposition temperature of the sealing material 30 and the melting point of the interposition film 13 may be, for example, 200° C. or less, 150° C. or less, or 100°° C. or less.

The positive electrode current collector foil 12 is attached to the first current collector plate 91 at one end in the stacking direction. The negative electrode current collector foil 14 is attached to the second current collector plate 94 at the other end in the stacking direction.

It should be noted that in another embodiment of the present disclosure, the bipolar battery 100 may be an all-solid-state battery. The all-solid-state battery includes a solid electrolyte instead of the electrolyte solution. The all-solid-state battery may include, for example, a sulfide solid electrolyte or the like.

### Method of Producing Recycled Material

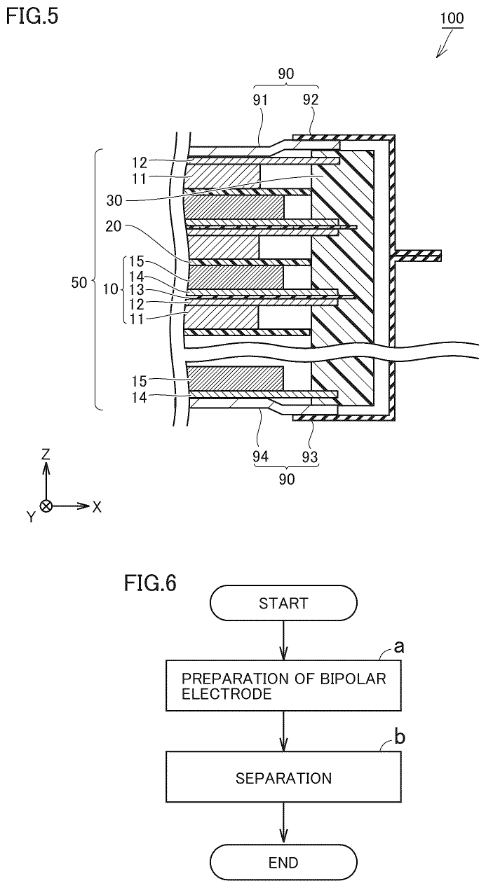

FIG. 6 is a schematic flowchart showing a method of producing a recycled material in the present embodiment. Hereinafter, the “method of producing a recycled material in the present embodiment” may be abbreviated as “the method”. The method includes “(a) preparation of bipolar electrodes” and “(b) separation”.

### (a) Preparation of Bipolar Electrode

The method includes preparing a bipolar electrode 10. For example, the bipolar electrode 10 may be recovered by disassembling the unneeded bipolar battery 100. For example, in the production process of the battery and the electrode, the bipolar electrode 10 discharged as a defective product may be recovered.

### (b) Separation

The method includes separating at least one of the positive electrode current collector foil 12 and the negative electrode current collector foil 14 from the interposition film 13 by stretching the interposition film 13 in the in-plane direction. Either one of the positive electrode current collector foil 12 and the negative electrode current collector foil 14 may be separated, or both the positive electrode current collector foil 12 and the negative electrode current collector foil 14 may be separated. Further, as shown in the first separation mode (FIG. 2), at least one of the positive electrode composite material layer 11 and the negative electrode composite material layer 15 may be separated.

For example, the protrusion 13a of the interposition film 13 may be clamped. For example, the interposition film 13 may be uniaxially stretched. For example, the interposition film 13 may be biaxially stretched. The biaxial stretching may be simultaneous biaxial stretching or sequential biaxial stretching. Stretching may be performed, for example, by a motive operation.

Various members separated from the interposition film 13 are recovered. The various members may be recycled in any manner. For example, various members may be reused. For example, a battery material (a current collector foil, an active material, or the like) may be recycled by components extracted from various members. For example, in applications other than batteries, the material may be reused.

What is claimed is:

1. A bipolar electrode comprising, in sequence in a plane-perpendicular direction:
a positive electrode composite material layer;
a positive electrode current collector foil;
an interposition film;
a negative electrode current collector foil; and
a negative electrode composite material layer, wherein
each of the positive electrode current collector foil and the negative electrode current collector foil is attached to the interposition film,
the positive electrode composite material layer is attached to the positive electrode current collector foil,
the negative electrode composite material layer is attached to the negative electrode current collector foil,
the interposition film has conductivity, and
the bipolar electrode is configured such that at least one of the positive electrode current collector foil and the negative electrode current collector foil is separated from the interposition film before the interposition film is broken when the interposition film is stretched in an in-plane direction.

2. The bipolar electrode according to claim 1, wherein the interposition film has a total elongation at break larger than a total elongation at break of each of the positive electrode current collector foil and the negative electrode current collector foil.

3. The bipolar electrode according to claim 1, wherein in the in-plane direction, the interposition film protrudes outward with respect to each of the positive electrode current collector foil and the negative electrode current collector foil.

4. A bipolar battery comprising the bipolar electrode according to claim 1.

5. A method of producing a recycled material, the method comprising:
(a) preparing the bipolar electrode according to claim 1; and
(b) separating at least one of the positive electrode current collector foil and the negative electrode current collector foil from the interposition film by stretching the interposition film in the in-plane direction.
